(19) United States
(12) Patent Application Publication
(10) Pub. No.: US 2006/0193265 A1
(43) Pub. Date: Aug. 31, 2006

(54) Peer-to-peer name resolution protocol with lightweight traffic

(75) Inventors: Radu Simionescu, Redmond, WA (US); Rohit Gupta, Redmond, WA (US); Christian Huitema, Clyde Hill, WA (US); John L. Miller, College Fields (GB); Ravi T. Rao, Redmond, WA (US); Adam Sapek, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: Microsoft Corporation, Redmond, WA (US)

(21) Appl. No.: 11/064,940

(22) Filed: Feb. 25, 2005

(51) Int. Cl. H04L 12/28; H04J 1/16; H04L 12/56

(52) U.S. Cl. 370/254; 370/401; 370/252

(57) ABSTRACT

A system, method, and computer product for a host node to participate in a peer network through a proxy, wherein the peer network includes a plurality of nodes, each node having a peer identifier (ID) and a cache of peer IDs for one or more known nodes, is provided. The method comprises acquiring the peer ID of a proxy node in the peer network; requesting the proxy node to act as a proxy; sending a message to at least one node in the peer network through the proxy node; and receiving a response from the at least one node in the peer network through the proxy node, wherein the at least one node in the peer network is unaware of a network address for the host node.

### FIELD OF THE INVENTION

The present invention relates generally to peer name resolution protocol and more particularly to a lightweight peer name resolution protocol for reducing the amount of traffic received by a peer in order to conserve resources.

### BACKGROUND OF THE INVENTION

Group communication technologies on the Internet allow users with common interest to collaborate, share files, chat with one another, multicast audio and video for presentations and group meetings, and engage in multi-player gaming. Indeed, the ability for group formation in an ad hoc basis presents significant advantages in allowing users with common interests to gather in a virtual area or group that may be segregated from the general Internet population. The segregation facilitates useful discussion in collaboration among such like-minded individuals. Currently, however, most group communication and formation takes place in a server-centric environment wherein all communication flows to or through large central servers.

With the emergence of peer-to-peer (P2P) technology, the current server-centric model of Internet communication is quickly being replaced. P2P technologies enable users to contact one another in a serverless environment, free from the constraints of server-based Internet communication. As with a server-centric environment, users form ad hoc groups for collaborating, sharing files, chatting, and gaming with one another. These groups, often referred to as clouds in the context of P2P networking, facilitate fast dissemination of common information throughout a distributed network of peers. However, unlike the server-centric environment, the P2P environment avoids bottlenecking and is more resilient to partial network disconnects.

A peer name resolution protocol, such as that described in commonly assigned U.S. patent application Ser. No. ______, is used by peers to resolve the address of other peers in a P2P cloud. Conventionally, peer name resolution protocols are “chatty,” in that there is a constant pinging of neighbor peers to maintain and update cache entries of peer addresses. As implemented, conventional peer name resolution protocols do not consider bandwidth or CPU usage. However, mobile devices, such as PDAs and cellular phones, may wish to participate in P2P clouds, but do not have the bandwidth or computational resources to keep up with the typical stream of P2P message traffic. Accordingly, there is a need in the art to allow such lightweight devices to participate in P2P clouds while conserving resources.

### BRIEF SUMMARY OF THE INVENTION

In view of the foregoing, the present invention provides a system, method, and computer product for a lightweight node to participate in a peer network through a proxy, wherein the peer network includes a plurality of nodes, each node having a peer identifier (ID) and a cache of peer IDs for one or more known nodes. The method comprises acquiring the peer ID of a proxy node in the peer network; requesting the proxy node to act as a proxy; sending a message to at least one node in the peer network through the proxy node; and receiving a response from the at least one node in the peer network through the proxy node, wherein the at least one node in the peer network is unaware of a network address for the host node.

Another embodiment of the invention provides a method for a proxy node to act as a proxy for a lightweight node in a peer network, wherein the peer network includes a plurality of nodes, each node having a peer identifier (ID) and a cache of peer IDs for one or more known nodes. That method includes receiving a request to act as a proxy, acknowledging the request, and registering a peer ID for the lightweight node, the peer ID having associated therewith a network address of the proxy node. The method may further comprise receiving a message from the lightweight node addressed to a target node, and forwarding the message to the target node, wherein a return path for the message includes the peer ID of the lightweight node and the network address of the proxy node. The method may still further include receiving a message from a node in the peer network that is intended for the lightweight node and forwarding the message to the lightweight node, wherein the message is intended for the peer ID of the lightweight node and the network address of the proxy node.

Yet another embodiment of the invention provides method for detecting a dead proxy node, wherein the proxy node acts as a proxy for a lightweight node in a peer network, the peer network including a plurality of nodes, each node having a peer identifier (ID) and a cache of peer IDs for one or more known nodes. That method comprise sending a message intended for the lightweight node to the proxy, waiting for a predetermined period of time for a reply, and sending a message directly to the lightweight node notifying the lightweight node that the proxy node is not functioning as a proxy.

Additional features and advantages of the invention are made apparent from the following detailed description of illustrative embodiments which proceeds with reference to the accompanying figures.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1A is a schematic generally illustrating an exemplary network environment across which the present invention operates.

FIG. 1B is a block diagram generally illustrating an exemplary computer system on which the present invention resides;

FIG. 2 depicts a system diagram in accordance with embodiments of the invention.

FIG. 3 depicts a resolution method by a lightweight node in accordance with embodiments of the invention.

FIG. 4 depicts a registration method of a lightweight node in accordance with embodiments of the invention.

FIG. 5 depicts a resolution method of a lightweight node in accordance with embodiments of the invention.

FIG. 6 depicts a proxy list maintenance method of a lightweight node in accordance with embodiments of the invention.

While the invention will be described in connection with certain preferred embodiments, there is no intent to limit it to those embodiments. On the contrary, the intent is to cover all alternatives, modifications, and equivalents as included within the spirit and scope of the invention as defined by the appended claims.

### DETAILED DESCRIPTION OF THE INVENTION

Turning to the drawings, wherein like reference numerals refer to like elements, the present invention is illustrated as being implemented in a suitable computing environment. The following description is based on embodiments of the invention and should not be taken as limiting the invention with regard to alternative embodiments that are not explicitly described herein.

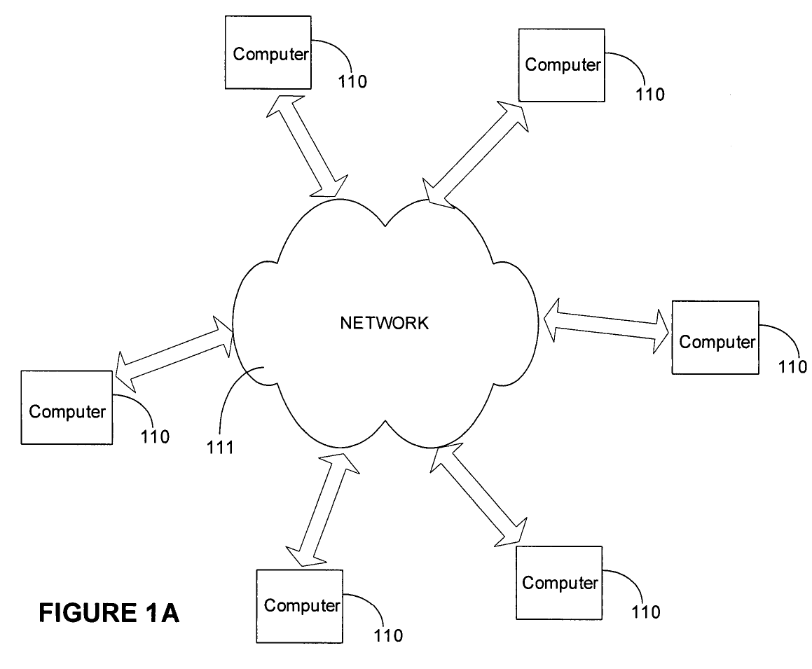

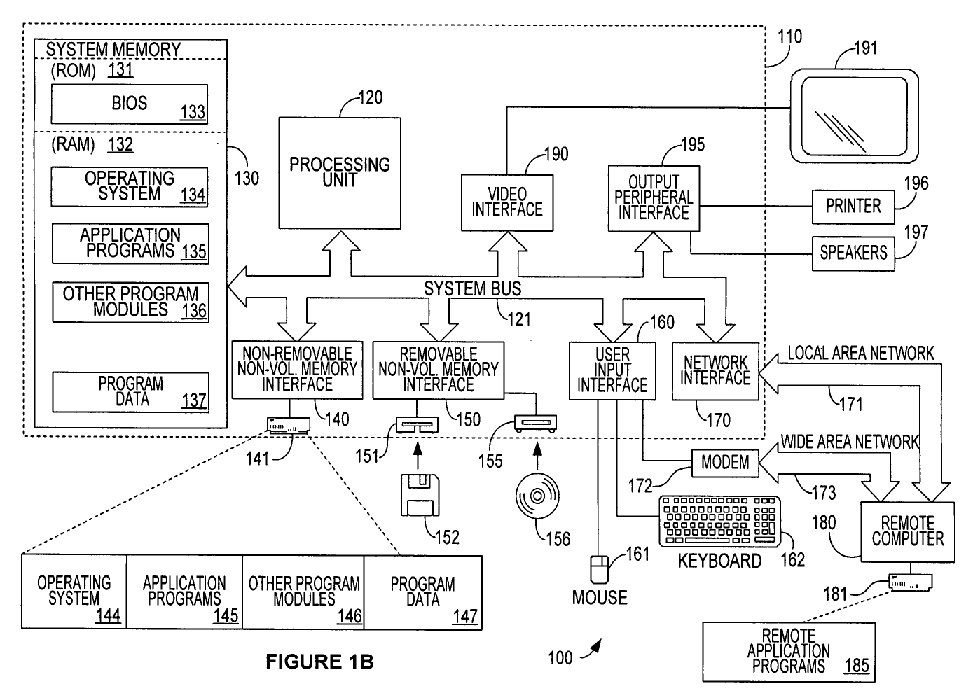

An example of a networked environment in which the invention may be used will now be described with reference to FIG. 1A. The example network includes several computers 110 communicating with one another over a network 111, represented by a cloud. Network 111 may include many well-known components, such as routers, gateways, hubs, etc. and allows the computers 110 to communicate via wired and/or wireless media. When interacting with one another over the network 111, one or more of the computers may act as clients, network servers, quarantine servers, or peers with respect to other computers. Accordingly, the various embodiments of the invention may be practiced on clients, network servers, quarantine servers, peers, or combinations thereof, even though specific examples contained herein do not refer to all of these types of computers.

FIG. 1B illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary computing environment 100.

The invention is operational with numerous other general-purpose or special-purpose computing system environments or configurations. Examples of well known computing systems, environments, and configurations that may be suitable for use with the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer-storage media including memory-storage devices.

With reference to FIG. 1B, an exemplary system for implementing the invention includes a general-purpose computing device in the form of a computer 110, which may act as a client, network server, quarantine server, or peer within the context of the invention. Components of the computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture bus, Micro Channel Architecture bus, Enhanced ISA bus, Video Electronics Standards Associate local bus, and Peripheral Component Interconnect bus, also known as Mezzanine bus.

The computer 110 typically includes a variety of computer-readable media. Computer-readable media can be any available media that can be accessed by the computer 110 and include both volatile and nonvolatile media, removable and non-removable media. By way of example, and not limitation, computer-readable media may include computer storage media and communication media. Computer storage media include both volatile and nonvolatile, removable and non-removable media implemented in any method or technology for the storage of information such as computer-readable instructions, data structures, program modules, or other data. Computer storage media include, but are not limited to, RAM, ROM, EEPROM, flash memory or other memory technology, CD-ROM, digital versatile disks or other optical disk storage, magnetic cassettes, magnetic tape, magnetic disk storage or other magnetic storage devices, or any other medium which can be used to store the desired information and which can be accessed by the computer 110. Communication media typically embody computer-readable instructions, data structures, program modules, or other data in a modulated data signal such as a carrier wave or other transport mechanism and include any information-delivery media. The term “modulated data signal” means a signal that has one or more of its characteristics set or changed in such a manner as to encode information in the signal. By way of example, and not limitation, communication media include wired media such as a wired network or direct-wired connection and wireless media such as acoustic, RF, infrared, and other wireless media. Combinations of the any of the above should also be included within the scope of computer-readable media.

The system memory 130 includes computer storage media in the form of volatile and nonvolatile memory such as read only memory (ROM) 131 and random access memory (RAM) 132. A basic input/output system 133 (BIOS), containing the basic routines that help to transfer information between elements within the computer 110, such as during start-up, is typically stored in ROM 131. RAM 132 typically contains data and program modules that are immediately accessible to or presently being operated on by the processing unit 120. By way of example, and not limitation, FIG. 1B illustrates an operating system 134, application programs 135, other program modules 136, and program data 137.

The computer 110 may also include other removable/non-removable, volatile/nonvolatile computer storage media. By way of example only, FIG. 1B illustrates a hard disk drive 141 that reads from or writes to non-removable, nonvolatile, magnetic media, a magnetic disk drive 151 that reads from or writes to a removable, nonvolatile, magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary computing environment 100 include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as the interface 140, and the magnetic disk drive 151 and the optical disk drive 155 are typically connected to the system bus 121 by a removable memory interface, such as the interface 150.

The drives and their associated computer storage media discussed above and illustrated in FIG. 1B provide storage of computer-readable instructions, data structures, program modules, and other data for the computer 110. In FIG. 1B, for example, the hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers to illustrate that, at a minimum, they are different copies.

A user may enter commands and information into the computer 110 through input devices such as a keyboard 162 and a pointing device 161, commonly referred to as a mouse, trackball, or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus. A monitor 191 or other type of display device is also connected to the system bus 121 via an interface, such as a video interface 190. In addition to the monitor 191, the computer 110 may also include other peripheral output devices such as speakers 197 and a printer 196 which may be connected through an output peripheral interface 195.

The computer 110 may operate in a networked environment using logical connections to one or more remote computers, such as a remote computer 180. The remote computer 180 may be another personal computer, a server, a router, a network PC, a peer device, or other common network node and typically includes many or all of the elements described above relative to the personal computer 110 although only a memory storage device 181 has been illustrated in FIG. 1B. The logical connections depicted in FIG. 1B include a local area network (LAN) 171 and a wide area network (WAN) 173 but may also include other networks. Such networking environments are commonplace in offices, enterprise-wide computer networks, intranets, and the Internet.

When used in a LAN networking environment, the personal computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the personal computer 110, or portions thereof, may be stored in the remote memory storage device 181. By way of example, and not limitation, FIG. 1B illustrates the remote application programs 185 as residing on the memory device 181. It will be appreciated that the network connections shown are exemplary, and other means of establishing a communications link between the computers may be used.

In the description that follows, the present invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

The present invention provides a system, method, and computer product for extending Peer-to-Peer Name Resolution Protocol to allow a lightweight node to interact in a peer-to-peer cloud through a proxy node, thereby conserving bandwidth and computational resources of the lightweight node. Throughout this specification, reference will be made to the PNRP before the invention as the “original PNRP,” while reference to the extended PNRP of the applicants' invention will be referred to as proxy-enabled PNRP.

In the various embodiments of the invention described below, normal PNRP node actively participates to the cloud by originating or forwarding of various messages. The traffic can be categorized as related to local registrations/resolutions, related to registrations/resolutions on behalf of others, and cache maintenance. These operations are vital to maintaining the consistency and dependability of the PNRP cloud, and thus cannot be abandoned. However, a lightweight node may have a network connection with limited bandwidth. The amount of traffic PNRP uses could overwhelm this limited network connection. In the case of a mobile computing device, the processing of PNRP messages could deplete the battery. Moreover, users usually pay by traffic, so paying for other node's resolutions will not be acceptable to them. Accordingly, in the various embodiments described below, a lightweight node finds a normal node (a proxy node) to perform these PNRP maintenance operations on its behalf.

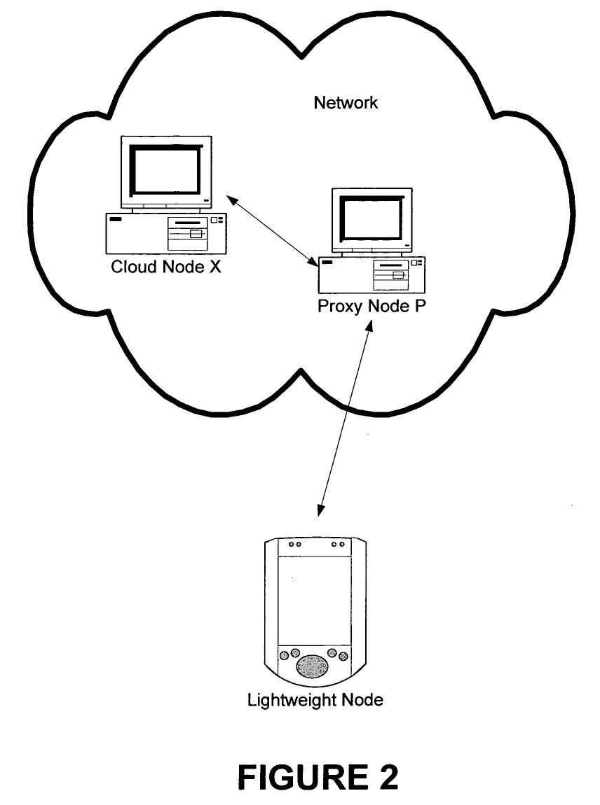

A lightweight node cache, instead of the cache maintained in a normal node, maintains a lightweight cache in which no “local machine CPA” is created. Locally originated resolutions are sent with an empty “best match CPA”. Furthermore, registrations are done through proxy nodes, which are normal nodes that are compliant with proxy-enabled PNRP. The proxy nodes will take the traffic hit. Moreover, no regular cache maintenance is performed by the proxied device; however the proxy host will still be responsible for its own regular cache maintenance. In one embodiment of the invention, a persisted cache of available proxies is maintained. The lightweight nodes operate in this “lightweight mode” by default, though normal nodes may still use this mode for traversing firewalls. Any node running proxy-enabled PNRP will support “remote registrations.” Seed servers attempt to maintain a list of proxy-enabled PNRP nodes. FIG. 2 illustrates a network cloud with at least one cloud node (X) and one proxy node (P). The lightweight node interacts with nodes in the cloud, like X, via the proxy node.

To allow a lightweight node to find a proxy-enabled PNRP node, a new “solicit controls” field is added to the PNRP SOLICIT message so the solicitor can specify what type of node IDs it wants the target to send back in the PNRP ADVERTISE message. One of these node types is “PNRP Proxy capable node.” Seed servers track the “PNRP Proxy node” capability and are able to send back IDs that match this criterion. In another embodiment of the invention, a preferred proxy may be hardcoded by storing the node ID of the proxy-node in a persisted memory, such as a registry key. In yet another embodiment of the invention, if the lightweight node is unable to find a proxy node to use to enter the cloud, proxy-enabled PNRP may provide a PNRP RESOLVE message with a special RF_* flag that is to be sent to a node in the cloud. The first node in the path supporting proxy-enabled PNRP will send back a PNRP RESPONSE message with including its node ID. In yet another embodiment of the invention, a list of proxy nodes is maintained PNRP nodes in the shared top level cache, so that a persisted cache can also be used when booting the lightweight node.

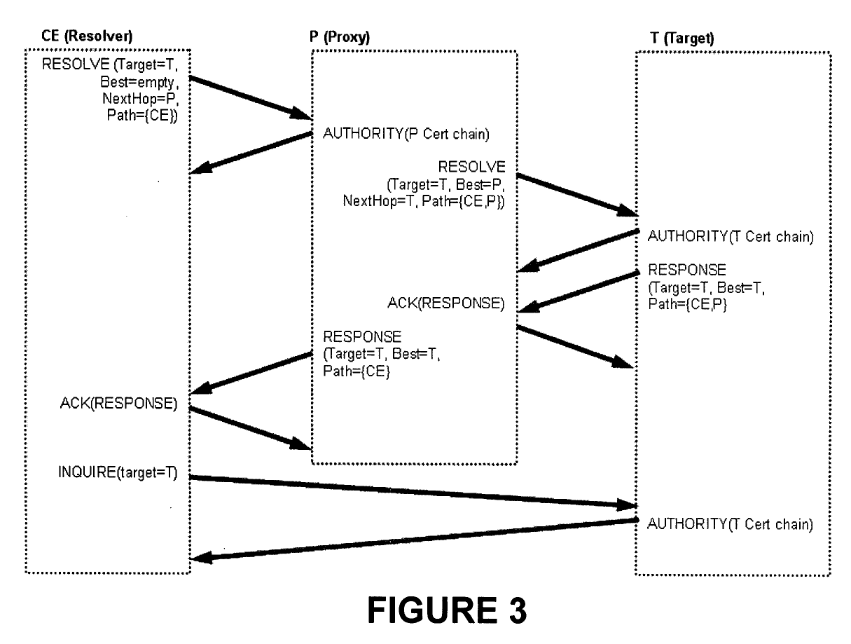

FIG. 3 illustrates a method for a lightweight node to resolve a proxy node. The RESOLVE message is sent to one of the proxies (could be the “closer” one or a random one) found by the previously described methods. The “Best match CPA” is empty so the lightweight node does not advertise itself to the world. The final INQUIRE message is sent either directly to the target (this works when total connectivity is available), or through the same proxy (if connecting to target T is expensive or impossible). A cache in lightweight mode does not need to create or maintain a “local machine CPA”.

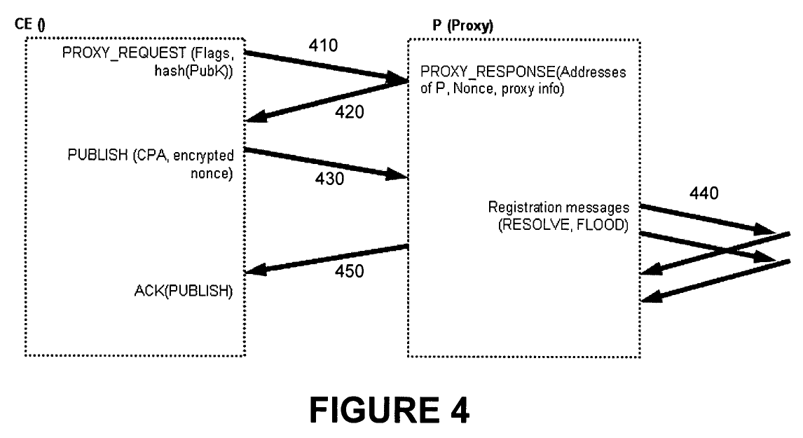

FIG. 4 illustrates a method by which a proxy node registers a node on behalf of a lightweight node. A user on the lightweight node calls the registration API for name N. At step 410, the lightweight node prepares and sends a PROXY_REQUEST message to one of the proxy nodes (P) in its list. The PROXY_REQUEST message fields may be “Hashed public key,” including a hash of the public key that will be embedded in the CPA, or Flags containing any message flags. At step 420, the proxy node sends back a PROXY_RESPONSE message that contains PROXY_RESPONSE message fields “Address array,” having as a value a list of PNRP service addresses used by the proxy node, “Nonce,” which is a random number, and “Proxy Info,” which is the number of available remote IDs and other information. At step 430, the lightweight node generates a CPA for the name and signs it with the identity private key. The CPA fields values may include:

Service Address: The list of PNRP service addresses received from the proxy node

Location: Service location derived from one of the addresses received from the proxy node

Payload 1: Addresses registered by the application

Payload 2: lightweight node service address

This way the service addresses in the CPA point to the proxy node, but the public key/signature are owned by the lightweight node.

The lightweight node then sends a PUBLISH message to the proxy node. The PUBLISH message fields include the CPA and an encrypted nonce that is a nonce received from proxy and encrypted with the identity private key. At step 440, the proxy nodes creates a view, sends the registration RESOLVE and FLOOD messages, then sends an ACK back to the lightweight node. At step 450, the lightweight node receives the ACK. If the proxy node does not have available slots for remote registrations, it may specify this fact in the PROXY_RESPONSE reply. The lightweight node will have to find another proxy and try again. Errors may also be returned through the final ACK by setting the NACK flag. The lightweight node will have to find another proxy and try again.

The proxy node may request certificate chain from a lightweight node using a regular INQUIRE/AUTHORITY transaction. The lightweight node is responsible for renewing the CPA. If the CPA expires on the proxy node and the lightweight node does not renew it, the proxy node will discard it. Renewal CPAs are registered using the same mechanism as for first time registration. Unregistration is similar to renewal, but the lightweight node sends a “revoke CPA” message instead of a regular message.

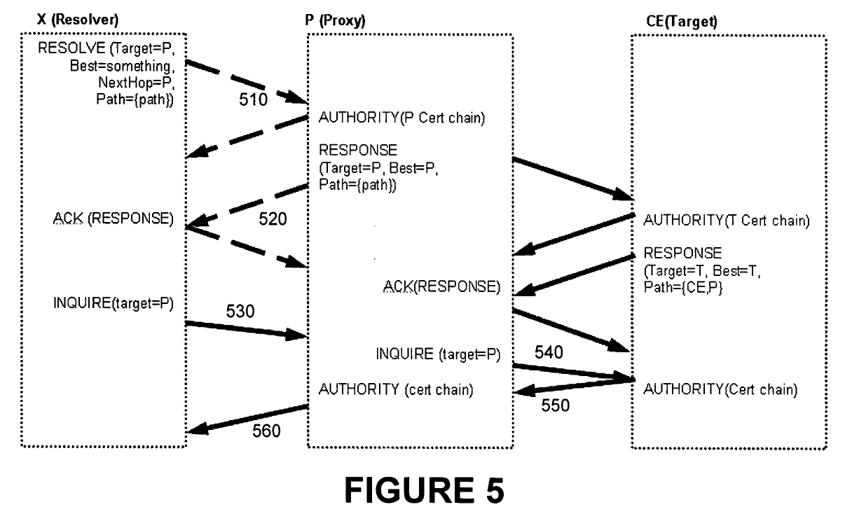

FIG. 5 illustrates the method for resolving a lightweight node. The RESOLVE messages are routed to the proxy node (P) because the proxy node's service addresses are the ones listed in the advertised CPA. At step 510, a cloud node (X) starts a resolution targeting the ID registered by the proxy node on behalf of lightweight node. At step 520, the RESOLVE reaches the proxy node, which replies with a RESPONSE with the lightweight node's CPA in the “best match CPA” field. At step 530, X sends an INQUIRE to the proxy node. At step 540, the proxy node forwards the INQUIRE to the lightweight node. At step 550, the lightweight node replies with an AUTHORITY message. At step 560, the proxy node forwards the AUTHORITY message to X (it may append the certificate chain obtained during publishing). A new flag is defined for INQUIRE messages so the inquiring node can specify whether the proxy node needs to forward the request to the lightweight node or it can just reply on its own. This way, INQUIRE messages sent to complete resolutions will be forwarded, and those triggered by nodes learning the registered CPAs will not.

Lightweight nodes may maintain a list of proxies in their top level cache. The list changes in time (proxies may come and go, or some of them may become unavailable for new registrations). The entries in the list are obtained through:

Bootstrapping (an initial list of proxies is returned by the lightweight bootstrap process)

Maintenance (regular PROXY_REQUEST messages are sent to the proxies in the list)

Learning—Neighbors of a proxy (in the ID space) can detect the proxy has died and may try to offer their proxy services to the lightweight node.

This helps reducing the frequency of polling needed to maintain the proxy list.

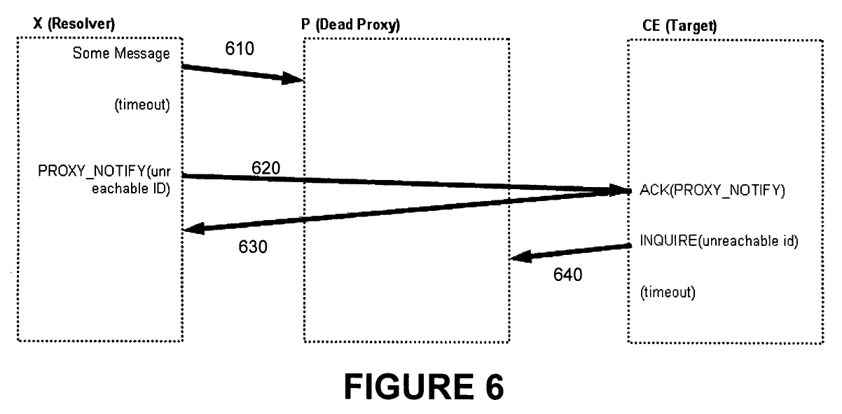

FIG. 6 illustrates the steps for dead proxy detection. At step 610, a cloud node (X) sends a message to the proxy node (P) based on the CPA owned by the proxy node on behalf of the lightweight node. If the cloud node supports proxy functionality and sending fails with timeout or any other relevant error (like AUTHORITY(AF_UNKNOWN_ID)), and the “Payload 2” field of the CPA has the flag “XF_ACCEPT_INCOMMING_NOTIFICATIONS” set, the process continues to step 2. At step 620, the cloud node extracts the address of the lightweight node from the CPA and sends a direct notification message to it (PROXY_NOTIFY). The message contains the ID that cannot be reached. At step 630, the lightweight node replies with an ACK. At step 640, the lightweight node checks the proxy node by sending an INQUIRE message to the proxy node. If the proxy node replies and confirms the CPA is still registered, the initial notification was unwarranted. Otherwise, the lightweight node should select another proxy and then reregister the names.

If some addresses on the proxy node change and they affect CPAs registered on behalf of a lightweight node, the lightweight node is notified so it can renew the affected CPAs. The proxy node sends a PROXY_NOTIFY to the lightweight node with a list of the invalidated IDs. The lightweight node acknowledges the message by replying with an ACK. The lightweight node then initiates renewal of CPAs on the proxy node. If the list of addresses returned by the proxy node is not different, the PROXY_NOTIFY was unwarranted and renewal stops.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for a host node to participate in a peer network through a proxy, wherein the peer network includes a plurality of nodes, each node having a peer identifier (ID) and a cache of peer IDs for one or more known nodes, the method comprising:
acquiring the peer ID of a proxy node in the peer network;
requesting the proxy node to act as a proxy;
sending a message to at least one node in the peer network through the proxy node;
receiving a response from the at least one node in the peer network through the proxy node, wherein the at least one node in the peer network is unaware of a network address for the host node.

2. The method of claim 1, wherein the peer ID of the proxy node is acquired from a seed server.

3. The method of claim 1, wherein the peer ID of the proxy node is persisted in a memory of the host.

4. The method of claim 1, wherein the host node is a mobile computing device.

5. A computer readable medium having stored thereon computer-executable instructions for performing the method of claim 1.

6. A method for a proxy node to act as a proxy for a lightweight node in a peer network, wherein the peer network includes a plurality of nodes, each node having a peer identifier (ID) and a cache of peer IDs for one or more known nodes, the method comprising:
receiving a request to act as a proxy;
acknowledging the request; and
registering a peer ID for the lightweight node, the peer ID having associated therewith a network address of the proxy node.

7. The method of claim 6, further comprising:
receiving a message from the lightweight node addressed to a target node; and
forwarding the message to the target node, wherein a return path for the message includes the peer ID of the lightweight node and the network address of the proxy node.

8. The method of claim 6, further comprising receiving a message from a node in the peer network that is intended for the lightweight node and forwarding the message to the lightweight node, wherein the message is intended for the peer ID of the lightweight node and the network address of the proxy node.

9. The method of claim 6, wherein the lightweight node is a mobile computing device.

10. A computer readable medium having stored thereon computer-executable instructions for performing the method of claim 6.

11. A method for detecting a dead proxy node, wherein the proxy node acts as a proxy for a lightweight node in a peer network, the peer network including a plurality of nodes, each node having a peer identifier (ID) and a cache of peer IDs for one or more known nodes, the method comprising:
sending a message intended for the lightweight node to the proxy;
waiting for a predetermined period of time for a reply; and
sending a message directly to the lightweight node notifying the lightweight node that the proxy node is not functioning as a proxy.

12. The method of claim 11, wherein the lightweight node is a mobile computing device.

13. A computer readable medium having stored thereon computer-executable instructions for performing the method of claim 11.
